(19) United States
(12) Patent Application Publication
(10) Pub. No.: US 2009/0166208 A1
(43) Pub. Date: Jul. 2, 2009

(54) ELECTROBIOLOGICAL TREATMENT DEVICE FOR ORGANIC SEWAGE

(75) Inventor: Yubo DONG, Beijing (CN)

Correspondence Address: YING CHEN;Chen Yoshimura LLP, 255 S. GRAND AVE., # 215, LOS ANGELES, CA, 90012, US

(73) Assignee: Beijing Jinaohuarong Science and Technology Co., Ltd., Beijing (CN)

(21) Appl. No.: 12/112,286

(22) Filed: Apr. 30, 2008

(30) Foreign Application Priority Data
Dec. 28, 2007 (CN) 200710304540.9

(51) Int. Cl. C02F 3/02

(52) U.S. Cl. 204/665

(57) ABSTRACT

The invention relates to an electrobiological treatment device for organic sewage, comprising a shell, a biological filler and one or more pairs of electrodes, wherein the biological filler and the electrodes are placed in the shell. The space inside the shell is separated into an outlet chamber, a reaction chamber and an inlet chamber by an upper distribution board and a lower distribution board, the reaction chamber positioned in the middle part in which the biological filter and the electrodes are placed. This device combines electrolysis treatment process with biological treatment process to exert oxidation reduction function of electrolysis treatment, improve conditions of biological treatment, increase treatment capability and get good effects.

### BACKGROUND OF THE INVENTION

1. Field of the Invention

The invention relates to a waste water treatment device, in particular to an aerobiont treatment device under the action of electric current.

2. Description of the Related Art

The prior treatment of organic sewage is usually realized through biological treatment mode, including anaerobe method, aerobiont method and anoxygenous biological method. An anaerobe method is usually adopted in a comprehensive treatment system and especially treatment of high-concentration organic sewage to degrade complex organic substance into simple organic substance. The aerobiont method is adopted to degrade organic substance into carbon dioxide and water. However, along with the development of industry, a lot of substances, such as chlorophenol, chlorobenzene, nitrobenzene and dye, not only pollute environment seriously but also are difficult to be biodegraded. Ordinary biological treatment is difficult to reach a perfect treatment effect to such pollutions.

### SUMMARY OF THE INVENTION

To overcome above defects of prior art, this invention provides an electrobiological treatment device for organic sewage. This device combines electrolysis treatment process with biological treatment process to exert oxidation reduction function of electrolysis treatment, improve conditions of biological treatment, increase treatment capability and get good effects.

The technical solution of the present invention to achieve above purposes is: an electrobiological treatment device for organic sewage comprising a shell, a biological filler and one or more pairs of electrodes, wherein the biological filler and the electrodes are placed in the shell, wherein the extension direction of the electrodes is vertical to that of the shell. Because there are biological filter materials inside the shell, the biomass in a unit volume and the biological treatment capability of the device is highly increased. When the electrodes are electrified, electrolysis is formed in water. The reaction of oxidation is enhanced and the consistency organism in water is reduced. The oxidant and reducing agent contact surrounding organisms directly so as to increase the speed of biological treatment, reduce the density of electrolysis resultant and increase the electrolysis effect. A mutual promotion of biological treatment and electrolysis treatment is formed. So this device has a better effect than that of two independent processes of electrolysis treatment and biological treatment. Although the mechanism of biological reaction under the electrolysis is not fully understood due to the complexity of the organisms, the mutual promotion of these two processes is affirmative. In addition, the vertical direction of electrodes will enable different part of water to pass by a similar alternative variation of electric field and avoid an uneven treatment to reduce total treatment effect of this device.

### BRIEF DESCRIPTION OF THE DRAWINGS

FIG. 1 is a schematic view of an electrobiological treatment device.

### DETAILED DESCRIPTION OF THE PREFERRED EMBODIMENTS

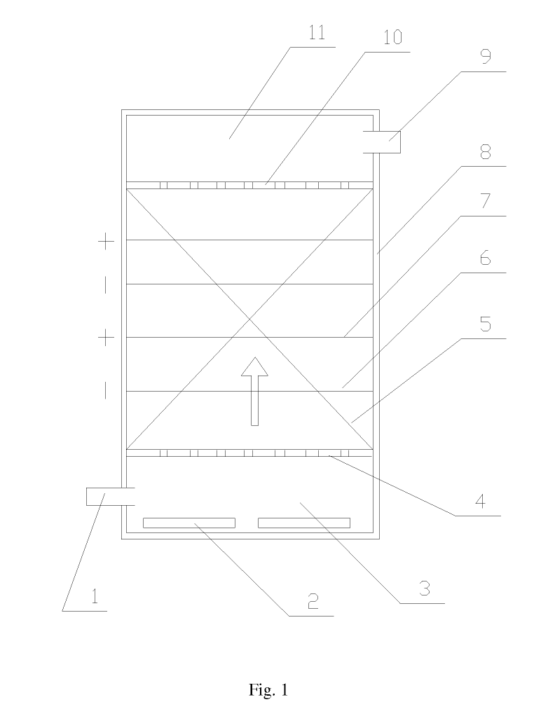

Refer to FIG. 1, the invention provides an electrobiological treatment device for organic sewage comprising a shell 8, a biological filler 5 and one or more pairs of electrodes, a pair of electrode including an anodes 7 and a cathodes 6, wherein the biological filler and the electrodes are placed in the shell, wherein the extension direction of the electrodes is vertical to that of the shell.

The space inside the shell is separated into an outlet chamber 11, a reaction chamber and an inlet chamber 3 by an upper distribution board 10 and a lower distribution board 4, the outlet chamber positioned at the upper part and including a water outlet pipe 1, the inlet chamber positioned at the lower part and including one or more air spargers 2 at its bottom, the reaction chamber positioned in the middle part in which the biological filter and the electrodes are placed, wherein the electrodes are horizontal.

The electrodes can be arranged horizontally or vertically. The anodes and cathodes should be arranged alternately and thread through the biological filter.

The biological filter may include organic high molecular padding, inorganic padding, sodium alginate or PVA.

The biological filter is stacked or suspended in the reaction chamber, wherein the stacking or padding rate of filter in the reaction chamber is 20% to 95%.

An explosion-proof warning device is arranged on top of the shell.

The anodes and cathodes may be electrodes of catalytic activity, made of carbon, iron, stainless steel, porous nickel, palladium, platinum or germanium.

The distance between adjacent anode and cathode is 20 to 500 mm.

The shape of the shell's cross section is round or rectangular.

The shell may be of a vertical structure. The water inlet is positioned at the lower part of the shell. The water flows upwards in the shell to reduce the resistance of water current.

The shell may be of a horizontal structure. The water flows in the shell horizontally to facilitate forming a longer length.

This device can achieve a higher degree of purification. When the electrodes are electrified, local electrolysis is formed in water and the generated oxidant and reducing agent conduct oxidation or reduction reaction toward the organism in water. The oxidant and reducing agent are directly in contact with the surrounding organisms so as to increase the speed of biological treatment, reduce the density of electrolysis resultant, cause the electrolysis level to develop towards the advantageous direction of the resultant and increase the electrolysis effect. Therefore, the mutual promotion of biological treatment and electrolysis treatment is formed, so the whole effect is better than the two independent processes of electrolysis treatment and biological treatment. Although the mechanism of biological reaction under the electrolysis is not fully understood due to the complexity of the organisms, this kind of mutual promotion structure is affirmative. In addition, the direction of electrodes is vertical to that of the water current so as to facilitate the variation of electric field of the route passed by the water current, enable the different water to pass by the similar alternative variation of electric field and avoid the uneven treatment effect of each part of water current from influencing the whole treatment effect.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. An electrobiological treatment device for organic sewage, comprising a shell, a biological filler and one or more pairs of electrodes, wherein the biological filler and the electrodes are placed in the shell.

2. The device of claim 1, wherein an extension direction of the electrodes is perpendicular to that of the shell.

3. The device of claim 1, wherein a space inside the shell is separated into an outlet chamber, a reaction chamber and an inlet chamber by an upper distribution board and a lower distribution board, the outlet chamber positioned at the upper part and including a water outlet pipe, the inlet chamber positioned at the lower part and including one or more air spargers at its bottom, the reaction chamber positioned in a middle part in which the biological filter and the electrodes are placed.

4. The device of claim 3, wherein each of the pairs of electrodes includes an anode and a cathode, wherein the anodes and the cathodes of the pairs of electrodes are arranged alternately and thread through the biological filter.

5. The device of claim 4, wherein the biological filter includes organic a high molecular padding, an inorganic padding, a sodium alginate or PVA.

6. The device of claim 5, wherein the biological filter is stacked or suspended in the reaction chamber, wherein the stacking or padding rate of filter in the reaction chamber is 20% to 95%.

7. The device of claim 6, further comprising an explosion-proof warning device which is arranged on top of the shell.

8. The device of claim 7, wherein a distance between adjacent anode and cathode is 20 to 500 mm.

9. The device of claim 8, wherein the shape of the shell's cross section is round or rectangular.

10. The device of claim 9, wherein the shell is of a vertical structure, wherein the water inlet is positioned in the lower part of the shell.

11. The device of claim 9, wherein the shell is a horizontal structure.

12. The device of claim 2, wherein a space inside the shell is separated into an outlet chamber, a reaction chamber and an inlet chamber by an upper distribution board and a lower distribution board, the outlet chamber positioned at the upper part and including a water outlet pipe, the inlet chamber positioned at the lower part and including one or more air spargers at its bottom, the reaction chamber positioned in a middle part in which the biological filter and the electrodes are placed.

13. The device of claim 12, wherein each of the pairs of electrodes includes an anode and a cathode, wherein the anodes and the cathodes of the pairs of electrodes are arranged alternately and thread through the biological filter.

14. The device of claim 13, wherein the biological filter includes organic a high molecular padding, an inorganic padding, a sodium alginate or PVA.

15. The device of claim 14, wherein the biological filter is stacked or suspended in the reaction chamber, wherein the stacking or padding rate of filter in the reaction chamber is 20% to 95%.

16. The device of claim 15, further comprising an explosion-proof warning device which is arranged on top of the shell.

17. The device of claim 16, wherein a distance between adjacent anode and cathode is 20 to 500 mm.

18. The device of claim 17, wherein the shape of the shell's cross section is round or rectangular.

19. The device of claim 18, wherein the shell is of a vertical structure, wherein the water inlet is positioned in the lower part of the shell.

20. The device of claim 18, wherein the shell is a horizontal structure.
